(19) United States
(12) Patent Application Publication
(10) Pub. No.: US 2024/0049736 A1
(43) Pub. Date: Feb. 15, 2024

(54) FROZEN PLANT-BASED PORTIONED MILK CONCENTRATE AND METHODS OF PREPARATION THEREOF

(71) Applicant: DAILY HARVEST, INC., New York, NY (US)

(72) Inventors: Rachel Drori, New York, NY (US); Richard Silver, New York, NY (US); Nevin Vijh, New York, NY (US); Laura Jane Kenny, Brooklyn, NY (US)

(21) Appl. No.: 18/257,045

(22) PCT Filed: Jan. 4, 2022
(86) PCT No.: PCT/US2022/011069

§ 371 Date: Jun. 12, 2023

Related U.S. Application Data
(60) Provisional application No. 63/135,284, filed on Jan. 8, 2021.

(51) Int. Cl. A23C 11/10; A23L 3/36; B65D 1/36

(52) U.S. Cl. CPC A23C 11/10; A23C 11/103; A23L 3/364; B65D 1/36

(57) ABSTRACT

An article and a method of making thereof. The article includes a frozen plant-based milk concentrate comprising water and at least 20 wt % ground paste, and a planar tray defining at least one compartment. Each compartment is sized to contain no more than four ounces of the frozen plant-based milk concentrate, and (ii) at least a portion of the frozen plant-based milk concentrate is disposed in and forms a wedge in the at least one compartment.

### RELATED APPLICATION

This application claims the benefit of priority to U.S. Provisional Application Ser. No. 63/135,284 filed Jan. 8, 2021, which is incorporated herein by reference in its entirety.

### BACKGROUND

Currently available non-dairy milk offerings are typically made by diluting a blended nut, seed, or cream base. These diluted offerings are stabilized and emulsified and sold in single strength formats in the grocery store. These offerings have a short shelf life after opening, are not very sustainable (packaging, processing, distribution), and do not let users customize for their preferences.

### SUMMARY

Embodiments of the invention enable freezing small portions of blended nut, seed, or cream “bases” into compartmentalized trays, thereby enabling single portions, customizable usage, long lasting shelf life, and much stronger sustainability. The consumer can add the individually frozen portions of plant-based milk concentrate directly to a liquid such as water at home to dilute into milk, or directly into smoothies, oatmeal, or other foods where milk is used for at home consumption.

In an aspect, embodiments of the invention relate to an article including a frozen plant-based milk concentrate comprising water and at least 20 wt % ground paste, and a planar tray defining at least one compartment. Each compartment is sized to contain no more than four ounces of the frozen plant-based milk concentrate. A least a portion of the frozen plant-based milk concentrate is disposed in and forms a wedge in the at least one compartment.

One or more of the following features may be included. The ground paste may include or consist essentially of a nut butter, a grain paste, a seed paste, and/or a fruit paste. The nut butter may include or consist essentially of almond butter, cashew butter, hazel nut butter, and/or pistachio butter. The grain paste may include or consist essentially of oat. The seed paste may include or consist essentially of hemp. The fruit paste may include or consist essentially of banana and/or coconut.

The milk concentrate may also include a spice, which may include or consist essentially of vanilla powder and/or salt.

The planar tray may include a plurality of compartments, e.g., up to twenty compartments. A perimeter of at least one compartment may define a trapezoid. A shortest edge of the trapezoid may have a length selected from a range of 0.1 inches to 0.7 inches. A perimeter of each compartment may define a trapezoid. Each compartment may be sized to contain at least 0.1 ounces of the frozen milk concentrate. Each compartment may be sized to contain no more than three ounces of the plant-based milk concentrate, e.g., no more than two ounces of the plant-based milk concentrate.

In another aspect, embodiments of the invention relate to a method of making an article including a planar tray defining at least one compartment with a wedge of frozen plant-based milk concentrate disposed in the at least one compartment. The method includes forming the plant-based milk concentrate by combining a ground paste and water, the plant-based milk concentrate including at least 20 wt % ground paste. The planar tray includes at least one compartment. No more than four ounces of the plant-based milk concentrate is disposed in the at least one compartment The plant-based milk concentrate is frozen to form the wedge in the at least one compartment.

The ground paste may include or consist essentially of a nut butter, a grain paste, a seed paste, and/or a fruit paste.

Forming the plant-based milk concentrate may include homogenizing the ground paste and water and/or pasteurizing the ground paste and water.

Providing the planar tray may include defining the at least one compartment by shaping a film with a die.

A perimeter of the at least one compartment may define a trapezoid.

A rollstock film may be disposed over the wedge in the at least one compartment.

At least 0.1 ounces of the plant-based milk concentrate may be disposed in the at least one compartment. No more than three ounces, e.g., no more than two ounces, may be disposed in the at least one compartment.

### BRIEF DESCRIPTION OF DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a perspective schematic drawing illustrating a planar tray suitable for use with an embodiment of the invention;

FIG. 1B depicts bottom and side views of the tray of FIG. 1A;

FIG. 1C depicts side and top views of a compartment of the tray of FIG. 1A, and a perspective view of a wedge formed therein; and

FIG. 2 is a flow chart illustrating a process for forming a frozen plant-based portioned milk product, according to an embodiment of an invention.

### DETAILED DESCRIPTION

As used herein, a “ground paste” is, e.g., a nut butter such as an almond butter, a cashew butter; a grain paste such as an oat paste, a seed paste; or a fruit paste, also referred to as a base.

As used herein, a “wedge” is a portion of frozen plant-based milk concentrate including a ground paste, also referred to herein as a milk wedge.

As used herein, “milk” is a liquid beverage formed by blending a wedge with a liquid, also referred to herein as finished milk.

Embodiments of the invention include plant-based milk concentrate wedges that may be blended with a liquid, e.g., water, to form a finished product comparable to commercially available dairy milk alternatives. The wedges may range in size from 0.1 ounces to 4.0 ounces, for example, 0.25 ounces to 3 ounces, 0.25 ounces to two ounces, 0.4 ounces or 0.5 ounces in size. In some embodiments, 1 oz of wedges may be converted to 8 oz of finished milk. Thereby, the user has the ability to create the desired finished product size by adjusting the number of wedges and the associated volume of additional liquid. Given the high nutritional value and functionality of each component, the user may reconstitute the wedges into a finished good by simply adding a liquid such as water and blending. The user may also choose to blend the wedge(s), liquid, and smoothie ingredients directly.

The wedges may include milk concentrate including water and at least 20 wt % ground paste, e.g., 50 wt % ground paste. Preferably, the wedges include a maximum of 80 wt % ground paste, e.g., a maximum of 75 wt %. Staying within this range provides the advantage of manufacturing/processing flexibility for the preparation of a highly concentrated formula, thereby reducing utility and shipping costs associated with freezing and transporting a larger volume of water. Also, the relatively high percentage of ground paste facilitates the provision of single portions with customizable usage, long lasting shelf life, and strong sustainability. Including more than 80 wt % ground paste, however, may result in the wedges having a very high viscosity, thereby hindering pasteurization.

The ground paste may include a nut butter, a grain paste, a seed paste, and/or a fruit paste. A suitable nut butter is, e.g., almond butter, cashew butter, hazel nut butter, or pistachio butter. A suitable grain paste may include oat. A suitable seed paste may include hemp. A suitable fruit paste may include banana or coconut.

The milk concentrate may also include a spice, such as vanilla powder or salt.

Examples of suitable frozen milk concentrate compositions include:
Almond milk (regular)=almond butter+salt+water
Almond milk (with vanilla)=almond butter+vanilla powder+salt+water
Cashew milk (regular)=cashew butter+salt+water
Cashew milk (with vanilla)=cashew butter+vanilla powder+salt+water
Oat milk (regular)=oat paste+salt+water
Oat milk (with vanilla)=oat paste+vanilla powder+salt+water
Pistachio milk (regular)=pistachio butter+salt+water
Pistachio milk (with vanilla)=pistachio butter+vanilla powder+salt+water
Coconut milk (regular)=coconut cream+salt+water
Coconut milk (with vanilla)=coconut cream+vanilla powder+salt+water
Hazelnut milk (regular)=hazelnut butter+salt+water
Hazelnut milk (with vanilla)=hazelnut butter+vanilla powder+salt+water
Banana milk (regular)=individually quick frozen (IQF) banana+salt+water
Banana milk (with vanilla)=IQF banana+vanilla powder+salt+water

Precise milk concentrate compositions may be as follows:

Almond Milk (with vanilla)

| Ingredient | Recipe wt % | |
|---|---|---|
| Almond Butter, Blanched, Unsalted, Organic, | 50.00 | wt % |
| Refrigerated | | |
| Vanilla Powder, Ground, 95% in 30 mesh, Conventional, | 0.18 | wt % |
| Dry | | |
| Water | 49.00 | wt % |
| Salt, Pink Himalayan, Extra Fine, Natural, Conventional, | 0.82 | wt % |
| Dry | | |
| | 100.00 | wt % |

Cashew Milk (with vanilla)

| Ingredient | Recipe wt % | |
|---|---|---|
| Cashew Butter, Roasted, Unsalted, Organic, Refrigerated | 50.00 | wt % |
| Vanilla Powder, Ground, 95% in 30 mesh, Conventional, | 0.18 | wt % |
| Dry | | |
| Water | 49.00 | wt % |
| Salt, Pink Himalayan, Extra Fine, Natural, Conventional, | 0.82 | wt % |
| Dry | | |
| | 100.00 | wt % |

Almond Milk (regular)

| Ingredient | Recipe wt % | |
|---|---|---|
| Almond Butter, Blanched, Unsalted, Organic, | 50.00 | wt % |
| Refrigerated | | |
| Water | 49.65 | wt % |
| Salt, Pink Himalayan, Extra Fine, Natural, Conventional, | 0.35 | wt % |
| Dry | | |
| | 100.00 | wt % |

Cashew Milk (regular)

| Ingredient | Recipe wt % | |
|---|---|---|
| Cashew Butter, Roasted, Unsalted, Organic, Refrigerated | 50.00 | wt % |
| Water | 49.65 | wt % |
| Salt, Pink Himalayan, Extra Fine, Natural, Conventional, | 0.35 | wt % |
| Dry | | |
| | 100.00 | wt % |

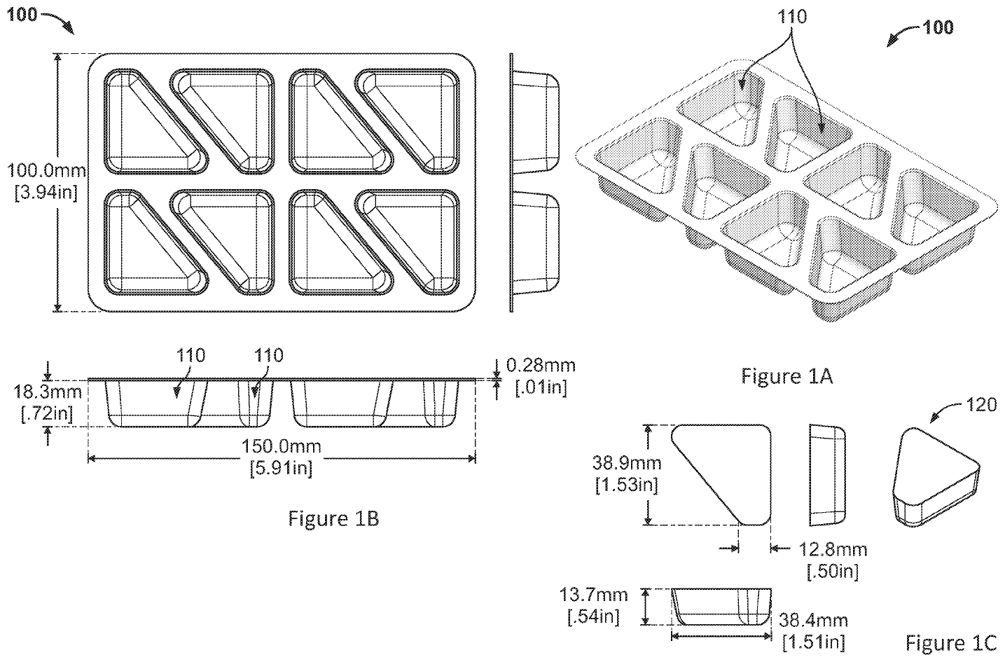

Referring to FIGS. 1A-1C, the wedges may be frozen in a planar tray 100 made from, e.g., PET, RPET, PHA, and/or molded fiber. A suitable material is rigid, with the tray being molded of plastic or wood fiber. The tray configuration may be a rectangular tray with individual compartments 110 for each wedge 120. The tray may have a perforated lidding film that enables wedges to be manually removed from the tray by the user.

Various tray dimensions and number of compartments may be used with various embodiments of the invention to allow for single serving and multiple serving product iterations, and accordingly a smaller or larger number of servings. A tray may include at least one individual compartment. e.g., 1 to 20 individual compartments. The range with a lower limit of 1 and a maximum of 20 allows the manufacturer flexibility in customizing product iterations to allow for a higher and lower numbers of wedges. Any more than 20 compartments in a tray may not be commercially viable, i.e., a tray with more than 20 suitably sized compartments is unlikely to fit in a typical user's freezer.

The compartments may be sized to hold no more than four ounces of a frozen plant-based milk concentrate including at least 20 wt % ground paste. In some embodiments, the compartments may be sized to hold no more than three ounces, no more than two ounces, or even less, e.g., as little as 0.1 ounces. An advantage of smaller maximum sizes may be improvement of blendability of the wedges formed in the corresponding compartments of the tray and flexibility in preparation of milk from the plant-based milk concentrate of the wedges. The wedges and corresponding compartments in the compartmentalized tray may be triangular, square, rectangular, or trapezoidal in the x/y dimension with a variable height/depth (z dimension). Exemplary dimensions of a wedge—and the dimensions of the corresponding compartment in a compartmentalized tray may be 1.5 in L×1.5 in W×0.75 in depth, with the overall tray having dimensions of, e.g., ˜4 in×8 in. In some embodiments, as illustrated in FIGS. 1A-1C, the wedges 120 may have perimeters defining trapezoids, with the shortest side having a length ranging from 0.1 inches to 0.7 inches. e.g., 0.5 inches, and the three longer sides each having a length selected from a range of 0.2 in to 2 in, e.g., 1 in. These shapes and dimensions provide for ease of blending/dilution while also facilitating ease of removal of the wedge from the packaging tray by the user. Moreover, as illustrated in FIG. 1A, a trapezoidal shape may allow reduction of the overall size of the tray with a compact arrangement of compartments.

Moreover, these wedge dimensions allow for ease of customization. For example, the consumer may use as few or as many wedges as he or she wishes, adding a prescribed or preferred volume of liquid such as water for blending, to achieve the volume and weight of desired finished product. Currently available alternative milk concentrates do not provide individually portioned wedges. Accordingly, currently available alternatives task the user with portioning the correct amount of concentrate using their own measuring device (e.g., a measuring spoon), whereas embodiments of the frozen portioned milk concentrate described herein eliminate the need for the use of any additional portioning device for preparing the concentrate for consumption.

The inventors have discovered that a tray, as described above, is preferable for packaging frozen milk concentrate wedges. Initial attempts to bulk pack wedges loosely in a non-compartmentalized cup were not successful. The cooler environment at the fulfillment centers warehouses)) in which the cups are packed into boxes is typically kept above the temperature required to keep the wedges individually frozen. Therefore the wedges packaged in cups started to thaw out and melt “into” each other, such that the concentrate became more of a glob, rather than discrete wedges. The inventors discovered modifications to the formula and individual compartmentalization to overcome these packaging challenges.

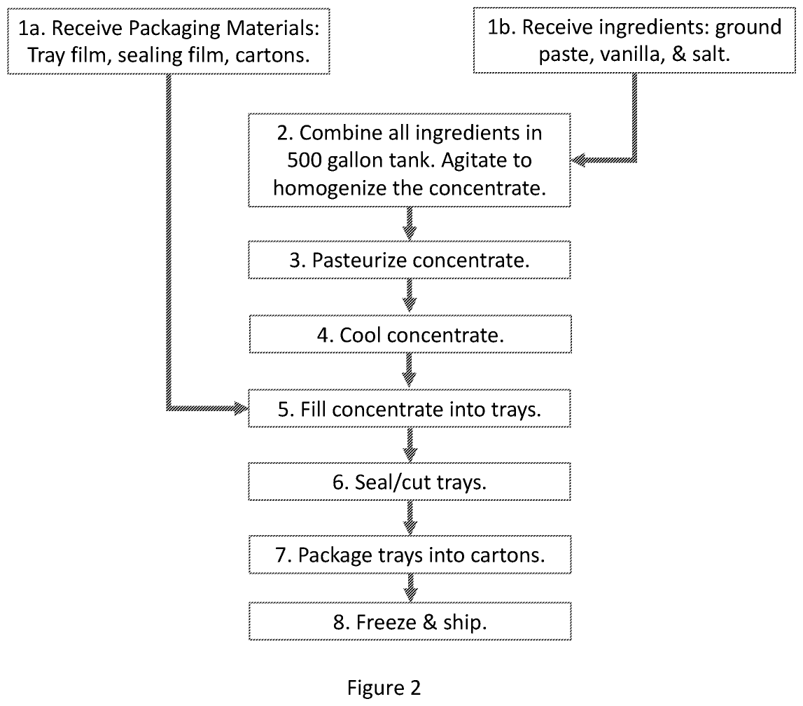

Referring to FIG. 2, an exemplary process flow is provided for freezing the plant-based milk concentrate compositions in the trays to form articles in accordance with embodiments of the invention.

In Step 1a, packaging materials are obtained. Typical packaging materials include tray film (rollstock), sealing film (rollstock), and cartons. The packaging materials are preferably stored in ambient and dry conditions. The tray film and sealing film are suitable for direct contact with food, e.g., FDA compliant. Exemplary materials include PET, RPET, PVC, and PLA, with a minimum thickness of 120 gauge and a maximum thickness of 20 gauge.

In parallel, in Step 1b, the food ingredients are obtained, e.g., from wholesale food suppliers. The preparation of the ingredients may include thermal treatment of any desired spices, e.g., vanilla, salt, etc., via roasting, blanching, or steam to reduce/eliminate bacterial growth. Thermal treatment may be followed by industrial grinding to a desired granulation specification. Suitable spice granulation and mesh screening may provide particles of 0.02 mm to 0.5 mm in diameter. Appropriate granulation size is up to the manufacturer's discretion, and is commonly influenced by desired final product characteristics, including texture and flavor intensity. Prior to use, the spice ingredients may be stored in ambient/dry conditions.

Another food ingredient is ground paste. Ground paste may be created by thermal treatment of a whole base ingredient such as almond, cashew, etc., via roasting, blanching, or steam. The thermal treatment is followed by grinding the base ingredient to a desired granulation specification. Suitable granulation may provide particles of 1 micron to 100 microns in diameter, as measured by a Particle Size Analyzer instrument. Appropriate granulation size is up to the manufacturer's discretion, and is commonly influenced by desired final product characteristics, including texture and flavor intensity.

Prior to use, the ground paste product may be stored in ambient/dry conditions, refrigerated, and/or frozen conditions. Ingredients may be packaged via, e.g., a 20 kg bag-in-a-box or a 5 gallon tub.

The food ingredients are combined in Step 2 as follows. The spice and ground paste ingredients are brought to ambient temperature, including thawing if necessary, and subsequently all ingredients are unpackaged. Quantities corresponding to the weight % formulas given above are measured and provided by using industrial weight scale and/or supplier-listed product weights and weighing containers, if needed. For example, for a 500 gallon batch of finished frozen plant-based milk concentrate, 250 gallons of ground paste are measured to obtain the specified 50% recipe concentration, and an appropriate amount of water is added to the ground paste. The ingredients may be manually transferred to a kettle such as an industrial 600 gallon steam-jacketed kettle (e.g., the D9MS manufactured by Lee Industries). The ingredients are mixed within the tank via a motorized agitator attachment until the resulting plant-based milk concentrate appears uniform, e.g., for approximately 10 minutes, thereby forming a homogenized concentrate.

The homogenized concentrate is pasteurized in Step 3. While the concentrate is still in the kettle, a steam-jacket may be used to heat the concentrate to comply with relevant food regulations, e.g., to a minimum of 167° F. for a minimum of 2 minutes to meet FDA and Process Authority guidelines. Alternatively, concentrate may be heated via circulation through a stainless steel pipe while in indirect contact with a hot water+steam pipe. A digital or manual temperature probe may be used to confirm that the internal concentrate temperature reaches 167° F. or above. Higher temperatures and longer times than those indicated here may result in denaturing of the base ingredient of the concentrate, i.e., the ground paste may scorch.

After pasteurization is complete, the plant-based milk concentrate is cooled in Step 4. For example, concentrate may be cooled in a kettle to an internal temperature of <120° F. by circulating cold water through the kettle cooling jacket or by circulating the product through a stainless steel pipeline while in indirect contact with a glycol or water pipeline. When concentrate is <120° F., the concentrate may be manually transferred from the pipeline to a sanitary drum or tote. The drum or tote may be placed in a refrigerated environment, e.g., <40° F., for filling within a timeframe as specified by a Certified Process Authority, e.g., 5 days.

When the concentrate reaches <40° F., the drum or tote may be opened and concentrate may be manually transferred to a tray sealer hopper.

The plant-based milk concentrate is placed into trays in Step 5. Within the tray sealer, pre-cast heated die may be used to form packaging trays from the rollstock film (made from, e.g., a PET or PLA material with a minimum thickness of 120 gauge and a maximum thickness of 20 gauge) with the shapes and dimensions described above. The trays may be continuously filled via a pneumatically-actuated filler. Examples of suitable commercially available tray sealers and fillers include units manufactured by Harpak-Ulma and AllFill. Concentrate is preferably filled at a temperature that is conducive for flow of the concentrate, for example, >32° F., or else the concentrate may freeze prior to deposition into the tray.

In Step 6, the trays and plant-based milk concentrate may be sealed, and the trays separated. In particular, the trays may be sealed with rollstock film (for example, a PET or PLA material with a minimum thickness of 120 gauge and maximum thickness of 20 gauge) within the tray sealer, and the trays are subsequently separated via an industrial stamping-cutter, or manual cutting device such as a sanitary scissors.

The trays are packaged in Step 7. Each tray may be manually placed into a carton, and the carton heat sealed.

The plant-based milk concentrate is frozen and the product shipped in Step 8 as follows. The cartons are placed into shipping cases, which are then placed on pallets and transferred to frozen storage. Freezing the concentrate results in the formation of wedges disposed in the compartments of the trays. To reduce risk of spoilage, the concentrate temperature preferably reaches a temperature of <0° F. within 5 days (or as otherwise specified by a Certified Process Authority) from the initial heat treatment and is stored frozen until intended use by a consumer.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. An article comprising:
a frozen plant-based milk concentrate comprising water and at least 20 wt % ground paste; and
a planar tray defining at least one compartment,
wherein (i) each compartment is sized to contain no more than four ounces of the frozen plant-based milk concentrate, and (ii) at least a portion of the frozen plant-based milk concentrate is disposed in and forms a wedge in the at least one compartment.

2. The article of claim 1, wherein the ground paste comprises at least one of a nut butter, a grain paste, a seed paste, or a fruit paste.

3. The article of claim 2, wherein the nut butter comprises at least one of almond butter, cashew butter, hazel nut butter, or pistachio butter.

4. The article of claim 2, wherein the grain paste comprises oat.

5. The article of claim 2, wherein the seed paste comprises hemp.

6. The article of claim 2, wherein the fruit paste comprises at least one of banana or coconut.

7. The article of claim 1, wherein the milk concentrate further comprises a spice.

8. The article of claim 7, wherein the spice comprises at least one of vanilla powder or salt.

9. The article of claim 1, wherein the planar tray comprises a plurality of compartments.

10. The article of claim 9, wherein the planar tray comprises a maximum of twenty compartments.

11. The article of claim 1, wherein a perimeter of at least one compartment defines a trapezoid.

12. The article of claim 11, wherein a shortest edge of the trapezoid has a length selected from a range of 0.1 inches to 0.7 inches.

13. The article of claim 11, wherein a perimeter of each compartment defines a trapezoid.

14. The article of claim 1, wherein each compartment is sized to contain at least 0.1 ounces of the frozen milk concentrate.

15. The article of claim 1, wherein each compartment is sized to contain no more than three ounces of the plant-based milk concentrate.

16. The article of claim 1, wherein each compartment is sized to contain no more than two ounces of the plant-based milk concentrate.

17. A method of making an article comprising a planar tray defining at least one compartment with a wedge of frozen plant-based milk concentrate disposed in the at least one compartment, the method comprising the steps of:
forming the plant-based milk concentrate by combining a ground paste and water, the plant-based milk concentrate comprising at least 20 wt % ground paste;
providing the planar tray comprising the at least one compartment;
disposing no more than four ounces of the plant-based milk concentrate in the at least one compartment; and
freezing the plant-based milk concentrate to form the wedge in the at least one compartment.

18. The method of claim 17, wherein the ground paste comprises at least one of a nut butter, a grain paste, a seed paste, or a fruit paste.

19. The method of claim 17, wherein forming the plant-based milk concentrate further comprises at least one of homogenizing the ground paste and water or pasteurizing the ground paste and water.

20. The method of claim 17, wherein providing the planar tray comprises defining the at least one compartment by shaping a film with a die.

21. The method of claim 17, wherein a perimeter of the at least one compartment defines a trapezoid.

22. The method of claim 17, further comprising disposing a rollstock film over the wedge in the at least one compartment.

23. The method of claim 17, wherein at least 0.1 ounces of the plant-based milk concentrate is disposed in the at least one compartment.

24. The method of claim 17, wherein no more than three ounces of the plant-based milk concentrate is disposed in the at least one compartment.

25. The method of claim 24, wherein no more than two ounces of the plant-based milk concentrate is disposed in the at least one compartment.
